(19) United States
(12) Patent Application Publication
(10) Pub. No.: US 2023/0237492 A1
(43) Pub. Date: Jul. 27, 2023

(54) MACHINE LEARNING FRAUD CLUSTER DETECTION USING HARD AND SOFT LINKS AND RECURSIVE CLUSTERING

(71) Applicant: PayPal, Inc., San Jose, CA (US)

(72) Inventors: Adam Inzelberg, Tel Aviv (IL); Ilan Voronel, Givataim (IL)

(21) Appl. No.: 17/584,810

(22) Filed: Jan. 26, 2022

(51) Int. Cl. G06Q 20/40; G06K 9/62

(52) U.S. Cl. CPC G06Q 20/4016; G06K 9/6219

(57) ABSTRACT

Systems and methods for detecting user account fraud rings are disclosed. In an embodiment, a computer system may access a plurality of user accounts created within a past period. The computer system may generate a tree of user accounts by recursively identifying pairs of user accounts by beginning with a seed account for the tree and iterating through user account pairs at lower branch levels to determine whether each user account has been paired to one or more other user accounts based on respective hard link features and soft link features. If a user account has been paired to one or more other user accounts, the computer system adds the one or more other user accounts to a branch level below the user account in the tree. The user accounts of the tree may be included in a cluster. Actions can be taken against the user accounts in the cluster.

### TECHNICAL FIELD

The present disclosure generally relates to enhancing computer security, and more particularly to detecting connections between certain user accounts using machine learning and artificial intelligence according to various embodiments.

### BACKGROUND

Fraud rings are a major issue for service providers in the online space. Fraud rings generally include groups of user accounts that are used to commit fraudulent activity, such as credit or application fraud, credit card testing, rewards fraud, trial abuse, checkout stalling, promotion abuse fraud, etc. Sophisticated fraud rings may be created by using scripts, which are designed to automate user account creation and can output millions of user accounts in a very short period of time in some cases. Fraud rings are known for being used as a tool to conduct fraudulent activity on a large scale which oftentimes results in large sums of monetary loss for the various victims involved, including individual customers and service providers. Unfortunately, online fraudulent financial schemes continue to increase in volume and technical sophistication. Therefore, there exists a need in the art for improved computer technology directed to timely detecting and stopping online fraudulent activity to provide more secure online platforms.

### BRIEF DESCRIPTION OF THE FIGURES

FIG. 1 illustrates a flow diagram of a process for generating training data to train a machine learning model to predict which user accounts that a seed account should be paired with in accordance with one or more embodiments of the present disclosure.

FIG. 2 illustrates a diagram of an example two-hop asset simulation to identify user accounts that share hard link features with a seed account in accordance with one or more embodiments of the present disclosure.

FIG. 3 illustrates a first diagram showing user accounts (vertices) that have been identified as user accounts that share at least one hard link feature with a seed account, and a second diagram showing the seed account and the identified user accounts split into seed-vertex pairs in accordance with one or more embodiments of the present disclosure.

FIG. 4 illustrates a flow diagram of a process for detecting and stopping user account fraud rings in accordance with one or more embodiments of the present disclosure.

FIG. 5 illustrates an example tree generated from a seed account by recursively identifying user account pairs in accordance with one or more embodiments of the present disclosure.

FIG. 6 illustrates a diagram of example clusters of user accounts that are unified based on at least one common user account between the clusters in accordance with one or more embodiments of the present disclosure.

FIG. 7 illustrates an example cluster that is unified with a previously generated cluster based on at least one common user account between the clusters in accordance with one or more embodiments of the present disclosure.

FIG. 8 illustrates a block diagram of a networked system in accordance with one or more embodiments of the present disclosure.

FIG. 9 illustrates a block diagram of a computer system implemented in accordance with one or more embodiments of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced using one or more embodiments. In one or more instances, structures and components are shown in block diagram form in order to avoid obscuring the concepts of the subject technology. One or more embodiments of the subject disclosure are illustrated by and/or described in connection with one or more figures and are set forth in the claims.

Online account origination fraud is a growing problem for electronic service providers. Online account origination fraud is hard to catch because when a user signs up for a new account, it is the first time a service provider sees that user and there is nothing to compare the user to, unlike authenticating a returning user. Bad actors often use scripted automation to create fake accounts, and increasingly, have been able to bypass bot-detection tools by using more sophisticated techniques, such as by mimicking human typing pauses or using real IP and location combinations.

The present disclosure provides a critical improvement in computer security technology for addressing the large volume and technical sophistication of user account fraud rings by using systems and methods that can be implemented to recognize when user accounts, often created in quick succession by scripts, are connected by hard features as well as more subtle soft link features. The soft link features are easily overlooked by human analysis and certainly are not detectable by humans at large scale unless machine learning techniques such as those discussed herein are implemented. The user accounts which are determined to be connected and assigned to clusters may be monitored and/or used as indicia of potential fraud rings that are attempting to carry out fraud and other computer security malfeasance on an electronic service provider's platform. By taking preventive action after early detection of the potential fraud rings, the fraudulent activity and computer security malfeasance taking place on electronic service providers' platforms can be eliminated or mitigated.

In one embodiment of the present disclosure, a computer system for an electronic service provider may access user accounts associated with the electronic service provider to obtain samples that the computer system can transform into training examples. For example, the computer system may access user accounts that were created in a certain time period (e.g., within the last month). The accessed user accounts may be considered seed accounts in a two-hop asset simulation in which the computer system may identify other user accounts that share hard link features with the seed accounts. Examples of hard link features may include an IP address, a name, a phone number, and other features that can be easily compared between user accounts. A hard link feature may be a strong connection (e.g., matching values) between user accounts that originates from one or more assets, such as the aforementioned examples, that are common to all user accounts.

Since there may be a large number of identified user accounts that share hard link features with the seed accounts, the computer system may filter the identified user accounts down to a less computationally complex number to process. For example, the computer system may filter the identified user accounts to only user accounts that were created within three days of a corresponding seed account. Filtering user accounts to those that were created within three days may be desirable as fraud rings oftentimes will create new accounts by script in quick succession over a short period of time such as three days.

After the computer system has filtered the user accounts, the computer system may split the seed accounts and corresponding identified user accounts into seed-vertex pairs. The computer system may enhance the seed-vertex pairs with soft link features corresponding to the seed account and vertex account of each pair. The soft link features may enhance the seed-vertex pairs with better characteristics of their relationship to facilitate finding pairs with a high probability to be actually linked when a model for predicting pairs is learned. Soft link features may include features that are more subtle than hard link features and difficult to distinguish between user accounts. Compared to hard link features, soft link features are more vague connections between two or more user accounts, where a connection is formed by analyzing behaviors that are shared between user accounts such as: username patterns, physiological behaviors, machine learning model similarities, etc.

The computer system may label the seed-vertex pairs to be used as training examples in learning a model that can be used to predict user account pairs. For example, the machine learning model may be used to predict whether a newly created user account should pair with one or more other recently created user accounts. The computer system may label the seed-vertex pairs based on onboarding tags that have been applied to the user accounts in the pair. For example, if the seed account and the vertex account in a seed-vertex pair were both tagged with “bad” tags indicating that they could possibly be fraudulent user accounts, the computer system may label the seed-vertex pair with a bad tag. As another example, if neither the seed account nor the vertex account were tagged with the bad tag at onboarding, the computer system may label the seed-vertex pair as “good.” Where one of the user accounts in the seed-vertex pair has a bad tag from onboarding, the computer system may label the seed-vertex pair as good to provide higher precision results rather than recall.

The trained machine learning model may be used in detecting and stopping potential fraud rings. For example, when a new user account is created, the computer system may pair the new user account with one or more other user accounts that were created within a certain recent period from the new user account based on input and output from the model. The computer system may then generate a tree comprising user accounts that are connected by pair relationships. For example, the computer system may identify user accounts for each branch level of the tree by beginning with the new user account as a seed account and recursively iterating through each paired user account as a seed account in a respective tree. Once all of the user accounts have been identified, a new cluster may be generated to include the user accounts of the tree.

However, if the new cluster shares at least one common user account with another previously generated cluster, the distinct user accounts of the new cluster may be combined with the user accounts of the other cluster in a unification operation such that all distinct user accounts now belong to a unified, larger-sized cluster of user accounts. Clusters of user accounts may be monitored for activity that would be considered fraud or steps toward committing fraud. In some cases, the computer system may take preventive action against certain clusters to prevent fraudulent activity from taking place on the electronic service provider's platform.

Further details and embodiments are described below in reference to the accompanying figures.

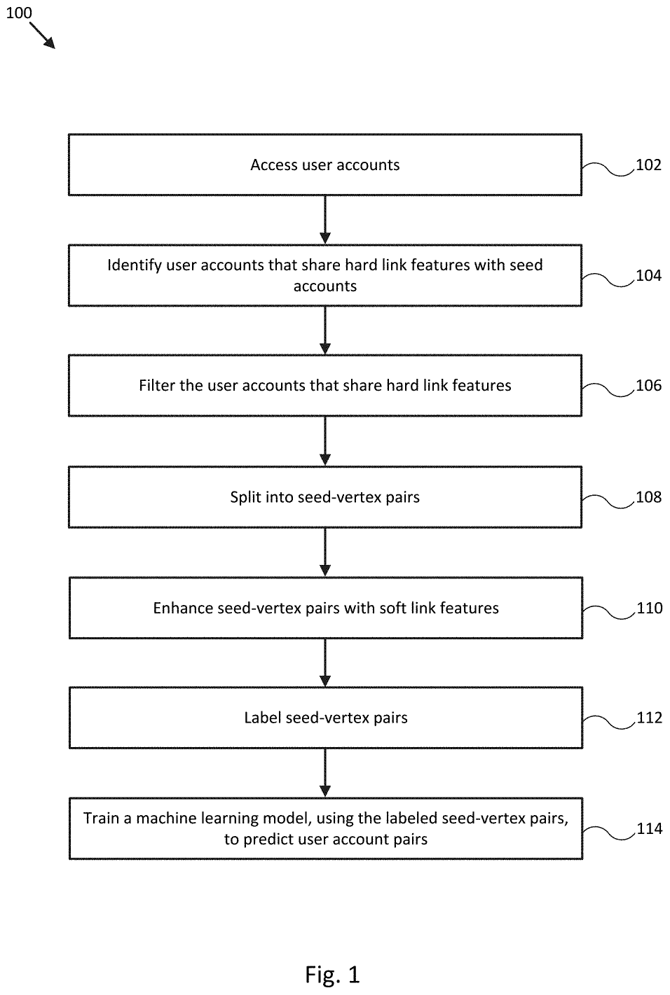

Referring now to FIG. 1, illustrated is a flow diagram of a process 100 for generating training data to train a machine learning model in accordance with one or more embodiments of the present disclosure. The blocks of process 100 are described herein as occurring in serial, or linearly (e.g., one after another). However, multiple blocks of process 100 may occur in parallel. In addition, the blocks of process 100 need not be performed in the order shown and/or one or more of the blocks of process 100 need not be performed in various embodiments.

It will be appreciated that first, second, third, etc. are generally used as identifiers herein for explanatory purposes and are not necessarily intended to imply an ordering, sequence, or temporal aspect as can generally be appreciated from the context within which first, second, third, etc. are used.

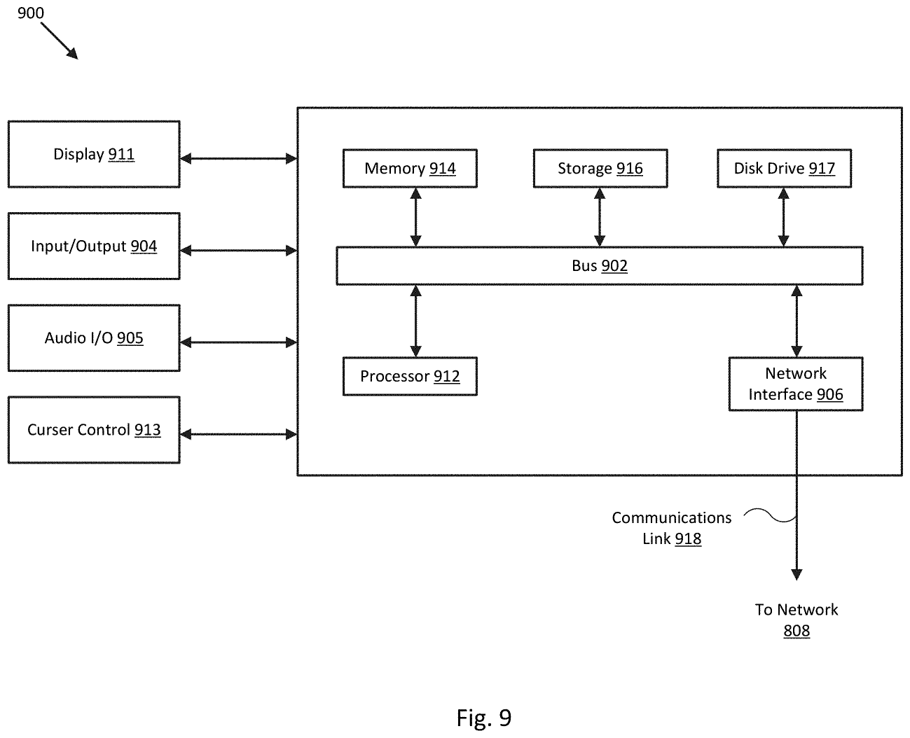

A computer system may perform the operations of process 100 in accordance with various embodiments. The computer system may be controlled and/or managed by an electronic service provider. The computer system may include a non-transitory memory (e.g., a machine-readable medium) that stores instructions and one or more hardware processors configured to read/execute the instructions to cause the computer system to perform the operations of process 100. In various embodiments, the computer system may include one or more computer systems 900 of FIG. 9.

In the context of online electronic services, an electronic service provider may provide services to a plurality of user accounts. For example, the user accounts may make various electronic service requests to the electronic service provider, to which the electronic service provider may respond by providing the requested electronic service. Generally, a service request to perform an action using the electronic service provider's platform may be considered a user account activity for a user account. User account activities, including actions and information inputted at user account onboarding, may be tracked/logged by the electronic service provider in a user account history for the user account. In some embodiments, the computer system may write the data corresponding to such user account activities to a cache or database and link the data to a key or other identifier that represents the user account so that lookup, polling, querying, and other such operations can be performed on the data using the key/identifier. The computer system may store such user account activities associated with the user account during a life cycle for the user account. The life cycle may be a predefined period of time for the user account, such as a month, a week, or longer periods such as from a beginning of the user account's existence (e.g., registration) to a present day. Various other data may be linked/tagged to the user account as further discussed herein.

At block 102, the computer system may access data associated with certain user accounts serviced by the electronic service provider. For example, the user accounts may be a sample of user accounts that were created (e.g., registered, signed up, onboarded), for use on the electronic service provider's platform, during a certain time period. For example, the user accounts may have been created during certain month(s) of the year or any other period that may be selected to provide a sufficient number of user accounts from which the computer system can create training data.

In some embodiments, the sample of user accounts may be selected based on tags associated with the user accounts. For example, a tag may indicate that the user account was tagged upon creation as potentially being a fraudulent or otherwise bad-intentioned user account. As an illustration, user accounts that registered/signed up during December through February and that have been tagged with a “bad” tag at onboarding may be selected as sample user accounts to access at block 102. A bad tag may indicate that the circumstances and characteristics of the user account's creation are indicative of a fake user account that could potentially be used for fraud.

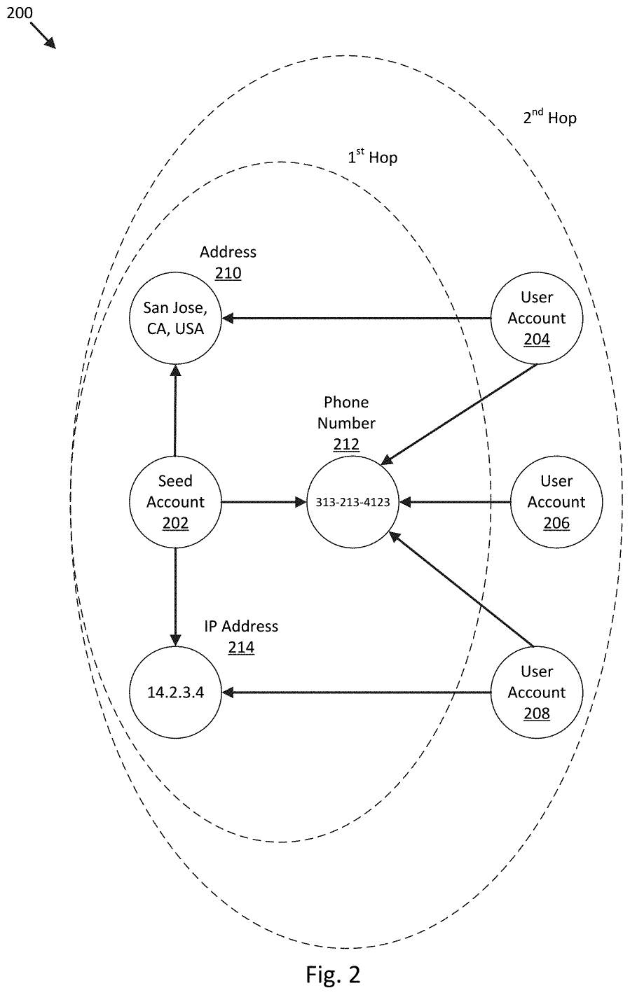

The selected user accounts that are accessed at block 102 may be considered seed accounts for block 104. At block 104, the computer system may identify user accounts that share hard link features with the seed accounts by running a two-hop asset simulation. For example, referring to diagram 200 of FIG. 2, a seed account 202 may be one of the user accounts accessed at block 102. Seed account 202 may have various hard link features. In some embodiments, hard link features may be easily recognizable features of seed account 202. Examples of hard link features are shown in FIG. 2 and include an address 210 (e.g., geolocation), a phone number 212, and an IP address 214. Further examples of hard link features include an email address, a computer identifier (ID), a mobile device ID (e.g., IMEI), a credit card number, a bank account number, etc.

In the example shown in FIG. 2, the computer system may identify user accounts 204, 206, and 208 as user accounts that share at least one hard link feature with seed account 202. For example, user account 204 shares the user account address 210 and the phone number 212 with seed account 202. User account 206 shares phone number 212 with seed account 202. User account 208 shares phone number 212 and the IP address 214 with seed account 202.

Referring back to FIG. 1, at block 106, the computer system may filter the user accounts that have been identified as sharing hard link features with seed accounts. The filtering at block 106 may be performed to reduce the number of user accounts that are identified in block 104 and consequently the computational complexity involved with processing such a large number of user accounts. For example, if the number of user accounts that are identified at block 104 exceeds a threshold for the number of desired user accounts from which to create sufficient training data, the user accounts can be filtered to reduce the number of user accounts to be within the threshold number to reduce the processing complexity for the computer system in performing process 100, while still maintaining a desired accuracy.

For example, in an embodiment, the computer system may filter the user accounts that share hard link features to remove user accounts that were created more than a period of time before the seed account 202. For example, referring again to FIG. 2, the computer system may filter user accounts that were created more than three days before seed account 202 in the second hop such that user accounts 204, 206, 208 are remaining as they were created within three days before the seed account's 202 creation.

In some embodiments, the computer system may filer the user accounts that share hard link features based on specific shared hard link features and/or number of hard link features shared. For example, the computer system may filter the identified user accounts down to those that share the same IP address, location, or phone number with a seed account. As another example, the computer system may filter the identified user accounts down to those that share at least two hard link features with a seed account. The above filters may be applied until the number of identified user accounts has been filtered to a desired number (e.g., below the aforementioned threshold).

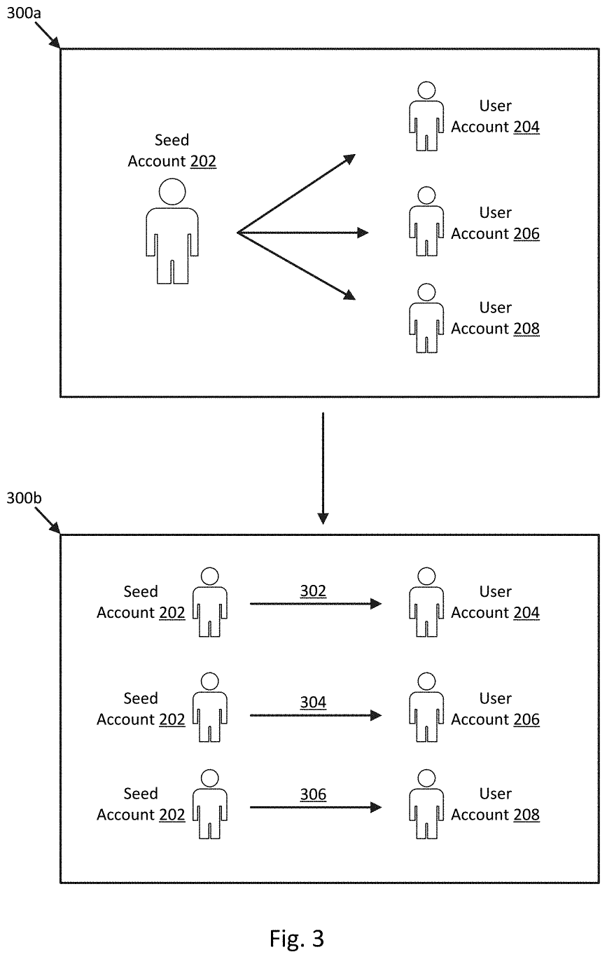

Referring back to FIG. 1, at block 108, the computer system may split the seed accounts and user accounts into seed-vertex pairs, where user accounts that have been identified for sharing at least one hard link feature with a seed account may be considered a vertex of the seed account. For example, referring to diagram 300a of FIG. 3, user accounts 204, 206, and 208 have been identified as user accounts that share at least one hard link feature with seed account 202. In accordance with the operations of block 108 and as shown in diagram 300b, the computer system may split seed account 202 and user accounts 204, 206, and 208 into seed-vertex pairs 302, 304, and 306. The seed-vertex pairs 302, 304, and 306 may be formatted by the computer system into training examples where hard link features of the seed accounts and user accounts in the seed-vertex pairs are used as features for training examples.

Referring back to FIG. 1, at block 110, the computer system may enhance the seed-vertex pair examples with soft link features. The combination of the hard link features and the soft link features for training examples may allow a model to be learned and used to predict user accounts that should be paired based on hard link and soft link features. In some embodiments, account level features may be added as soft link features, such as ID20 scores, behavioral features (e.g., name length), RDA (e.g., browser, resolution), seed (LegoGen variable). In further embodiments, pair relationship features may be added as soft link features between seed-vertex paired user accounts, such as matches in an email pattern, an account type (e.g., whether pair user accounts are personal or business accounts), RDA variables (e.g., browser type, resolution, etc.), typing speed (e.g., measuring keyboard typing speed and cadence), geographical location, domain riskiness (e.g., analyzing user website/email domain), Gibberish match (e.g., determining whether a username has a meaning or is just gibberish indicating it may be a fake user account), phone parameters (e.g., device model, version), and SHODAN (e.g., domain riskiness data source). The matches in pair relationship features may be variables that are marked as 0 (no match) or 1 (match) according to various embodiments.

As another example, group level features may be added as soft link features, such as averages and sums of account and pair level features. For example, referring to FIG. 3 again, an average or sum of the pair variables for the original group of user accounts in diagram 300a can be determined and used as soft link features for enhancing the seed-vertex pairs in diagram 300b. As an illustration, if two of the three pairs in the original group have a match in email pattern (two of the pairs have the email pattern match variable marked as 1 while one pair as the variable marked as 0), a new variable for the seed-vertex pairs, such as a group email pattern match average, would be equal to 0.66.

Referring again to FIG. 1, at block 112, the computer system may label the seed-vertex pairs to provide training examples from which a machine learning algorithm can learn a model to predict user account pairs. In some embodiments, the computer system may label certain seed-vertex pairs with a label indicating that the pair of user accounts are “bad” (e.g., fraudulent). For example, in some cases, if the user accounts of the pair were both tagged with the bad tag by the electronic service provider at creation and onboarding, the pair may be labeled as bad. In other cases, where neither user account in a seed-vertex pair has a bag tag, the seed-vertex pair may be labeled as “good.” If there is one user account in a seed-vertex pair that has a bad tag while the other user account does not have the bad tag, the seed-vertex pair may be labeled as good. By using this labeling methodology, the computer system employs a strict mechanism aimed at providing higher precision results rather than recall.

Once the seed-vertex pairs have been labeled to provide training examples, at block 114, the computer system may use the labeled seed-vertex pairs as examples to train a machine learning algorithm to learn a model that is usable to predict user account pairs. Various machine learning algorithms may be implemented to train a machine learning model to predict user account pairs as would be understood by one having skill in the art. For example, XGBoost may be used to train a machine learning model to predict pairs according to some embodiments.

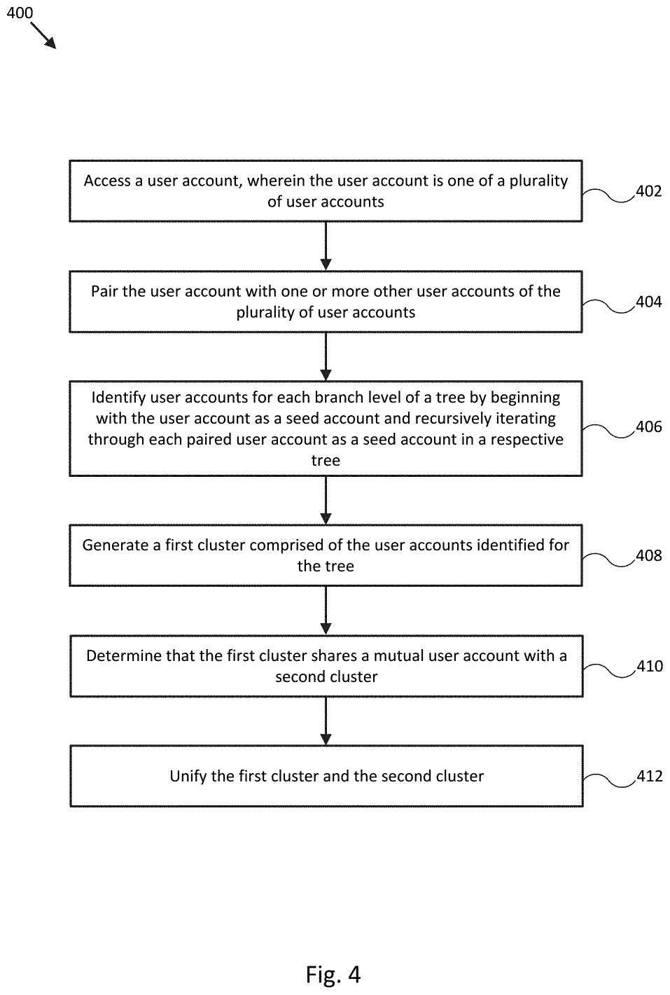

Now referring to FIG. 4, illustrated is a flow diagram of a process 400 for detecting and stopping user account fraud rings in accordance with one or more embodiments of the present disclosure. The blocks of process 400 are described herein as occurring in serial, or linearly (e.g., one after another). However, multiple blocks of process 400 may occur in parallel. In addition, the blocks of process 400 need not be performed in the order shown and/or one or more of the blocks of process 400 need not be performed in various embodiments.

At block 402, the computer system may access a user account, which may be one user account of a plurality of user accounts accessible by the computer system. For example, the plurality of user accounts may be serviced by the electronic service provider. In some embodiments, the computer system may access the user account via a database (and/or associated databases) containing data associated with the plurality of user accounts.

In some embodiments, the identifiers for the plurality of user accounts may be obtained by filtering the user accounts in the database and/or associated databases. For example, the computer system may filter all or a set of user accounts registered with the electronic service provider based on time of creation. To illustrate, the plurality of user accounts may be user accounts that have been created within a past period of time (e.g., user accounts created within the past three days). Thus, the user account accessed at block 402 may be one of the recently created user accounts within the past period of time.

In some embodiments, the user account accessed at block 402 may be the most recent user account created within the past period of time. For example, the computer system may run the process 400 in an ongoing manner to act on each newly created user account, and the user account accessed at block 402 may be the most recently created user account for the electronic service provider's platform.

At block 404, the computer system may pair the user account with one or more other user accounts from the plurality of user accounts. For example, the computer system may use the model trained in process 100 to predict one or more other user accounts from the plurality of user accounts to which the accessed used account should be paired. The trained model may make the pair prediction based on hard link features and soft link features associated with the accessed user account and the hard link and soft link features of the plurality of user accounts. In some circumstances, the machine learning model may predict that there are no other user accounts to which the accessed user account should be paired, in which case the accessed user account may be annotated as not having any pairings to other user accounts. However, the operations of process 400 generally assume that the accessed user account at block 402 has been predicted to pair to one or more other user accounts at block 404 based on hard link features and soft link features.

At block 406, the computer system may identify user accounts for each branch level of a tree by beginning with the accessed user account from block 402 as a seed account for the tree and recursively iterating through each paired user account and its respective tree.

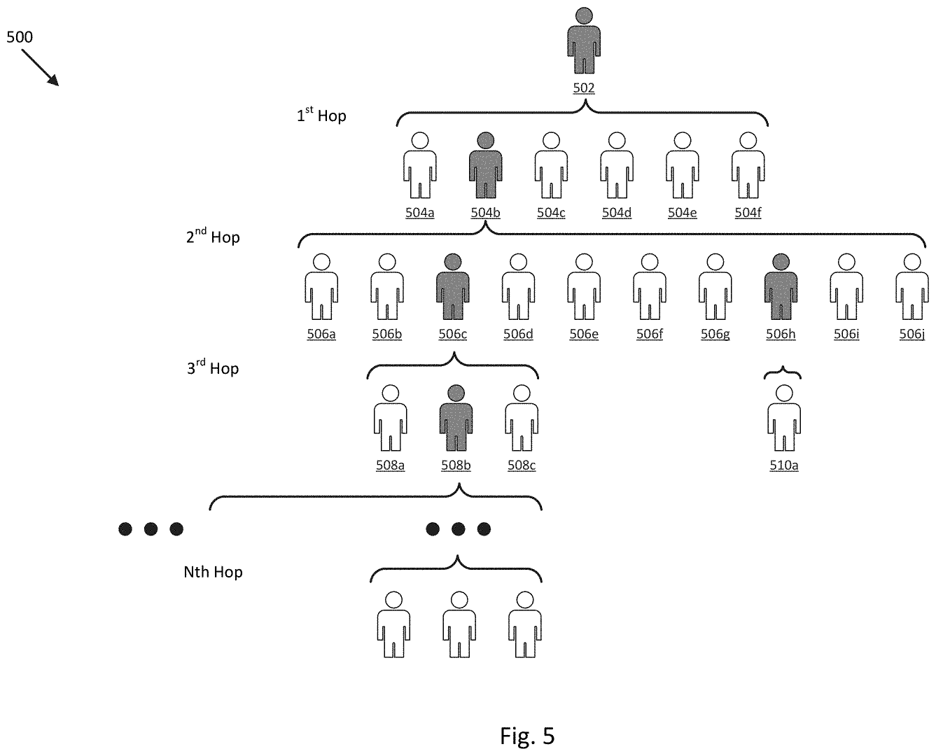

FIG. 5 shows an example of such a tree 500, where the accessed user account may be established as a seed account 502 of the tree 500 that the computer system generates for the seed account 502. The computer system may begin with the seed account 502 and identify user accounts that have been paired with the seed account 502. For example, the computer system may have used the model trained in process 100 to predict user accounts to pair to the seed account 502 upon creation (e.g., at sign up, registration) of the seed account 502. In the example shown in FIG. 5, user accounts 504a-f were paired to the seed account 502, so the computer system identifies user accounts 504a-f within a first hop of the seed account 502 in a recursive process for generating the tree 500 of user accounts connected to the seed account 502. The user accounts that are identified within the first hop may be considered user accounts corresponding to a first branch level of the tree 500.

The computer system may then move to a second hop from seed account 502 to identify user accounts for a second branch level of the tree 500. That is, if any of the user accounts 504a-504f have user accounts that were paired thereto, the computer system will identify such user accounts in the second hop in a recursive fashion. In this way, the computer system is accessing each of the user accounts 504a-504f to determine if the computer system had generated trees with respect to the user accounts 504a-504f similar to how the computer system is generating tree 500 for seed account 502. As shown in FIG. 5, user account 504b was paired with user accounts 506a-506j, thus user accounts 506a-506j are identified in the second hop from the seed account 502 at a second branch level of tree 500.

Similarly, if any of the user accounts 506a-506j have user accounts that were paired thereto (such as when each of the user accounts 504a-504f were created and the computer system generated their respective trees similar to how the computer system is generating tree 500) the computer system will identify user accounts in the next hop (the third hop) in a recursive fashion. As shown in FIG. 5, user account 506c was previously paired with user accounts 508a-508c, thus user accounts 508a-508c are identified in the third hop from the seed account 502 for a third branch level of the tree 500. Further, a user account 506h was previously paired with a user account 510a, thus the computer system may also identify user account 510a in the third hop from the seed account 502 for the third branch level of the tree 500.

In some embodiments, the recursive operations at block 406 may continue until a base case (e.g., user accounts without further paired user accounts) is reached. In some embodiments, the recursive operations at block 406 may continue until an Nth hop is realized. The Nth hop may be predefined and intended to limit the computational complexity involved with generating the tree 500 such that the tree 500 can be generated by the computer system in a time-efficient manner.

Referring back to FIG. 4, at block 408, the computer system may generate a first cluster comprised of the user accounts identified for the tree 500. For example, the computer system may tag each of the user accounts identified for the tree 500 with an identifier associated with the first cluster. Thus, the computer system can refer to the identifier when querying a user account database for information regarding the user accounts in the first cluster.

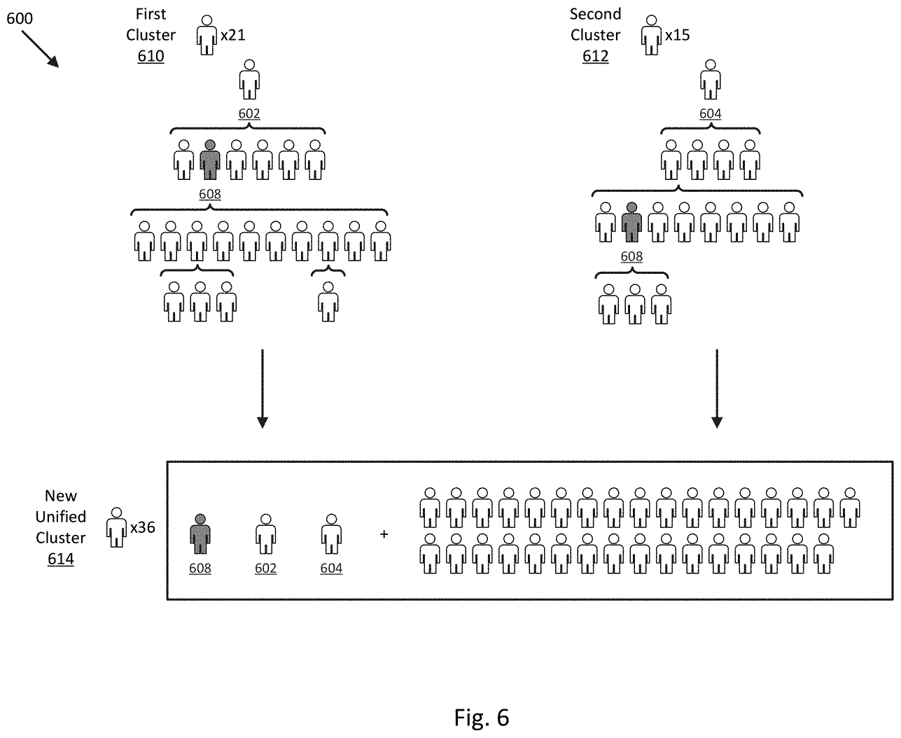

At block 410, the computer system may determine that the first cluster shares a mutual (e.g., same) user account with a second cluster. For example, referring to diagram 600 of FIG. 6, illustrated is a first cluster 610 that has 21 user accounts and a second cluster 612 that has 15 user accounts. As an illustration of a possible scenario, the first cluster 610 may have been generated first in time and in response to the creation of a seed account 602. The second cluster 612 may have been generated second in time and in response to the creation of a seed account 604.

The computer system may compare the user accounts in the first cluster 610 to the user accounts in the second cluster 612 to determine whether the first cluster 610 and the second cluster 612 have at least one mutual user account. As shown in FIG. 6, the computer system may determine that the first cluster 610 and the second cluster 612 share a mutual user account 608. If the computer system determines that the first cluster 610 and the second cluster 612 share the mutual user account 608, the computer may proceed to block 412 of process 400 of FIG. 4.

At block 412, the computer system may unify the first cluster 610 and the second cluster 612 in response to determining there is at least one commonly shared user account. For example, as shown in FIG. 6, the computer system may generate a new unified cluster 614 to which each of the user accounts belonging to the first cluster 610 and the second cluster 612 may be assigned.

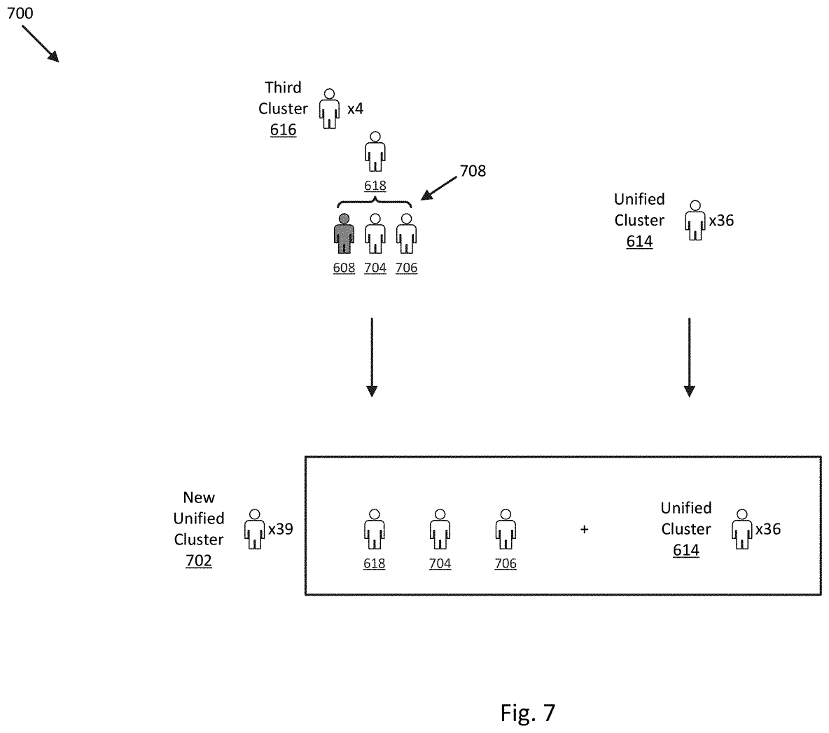

Thus, as user account clusters are generated and commonality between clusters are found, new unified clusters can be generated to connect user accounts. To further illustrate, referring to diagram 700 of FIG. 7, a seed account 618 may have been recently created. The computer system may generate a tree 708 of user accounts that are connected to the seed account 618 (e.g., by performing the operations discussed above related to recursive iteration to identify paired user accounts). Tree 708 may include seed account 618 and user accounts 608, 704, and 706. The computer system may generate a third cluster 616 comprised of the user accounts of tree 708 (user accounts 618, 608, 704, and 706). The computer system may compare third cluster 616 to previously generated clusters to determine if there is a commonly shared account between third cluster 616 and any other previously generated cluster. For example, the computer system may determine that third cluster 616 shares user account 608 in common with the unified cluster 614 from FIG. 6. In response to determining that there is a match for at least one commonly shared user account, the computer system may generate a new unified cluster 702 that includes the user accounts from the third cluster 616 and the unified cluster 614 (without duplication of user accounts).

The clusters of user accounts determined by the computer system may be used as indications of user accounts that potentially belong to fraud rings. In some embodiments, the computer system may take preventive actions against clusters of user accounts. For example, the computer system may restrict user accounts in certain clusters. In some embodiments, restricting user accounts in a cluster may include blocking the user accounts from executing electronic transactions with other user accounts, preventing withdrawals, or performing other user account activities.

Thus, the present disclosure provides a critical improvement in technology for addressing technical problems associated with sophisticated online fraud rings in which fake user accounts are created, often in quick succession, by automated scripts. Machine learning and artificial intelligence can be implemented to recognize when user accounts are connected by hard link features as well as more subtle soft link features, which often cannot be detected by human analysis and certainly are not detectable by humans at large scale, unless machine learning techniques such as those discussed herein are implemented. The user accounts that are connected together in clusters may be potential fraud rings and can be monitored on an electronic service provider's platform. By taking preventive action after early detection of potential fraud rings, fraudulent activity and computer security malfeasance taking place on electronic service providers' platforms can be eliminated or mitigated.

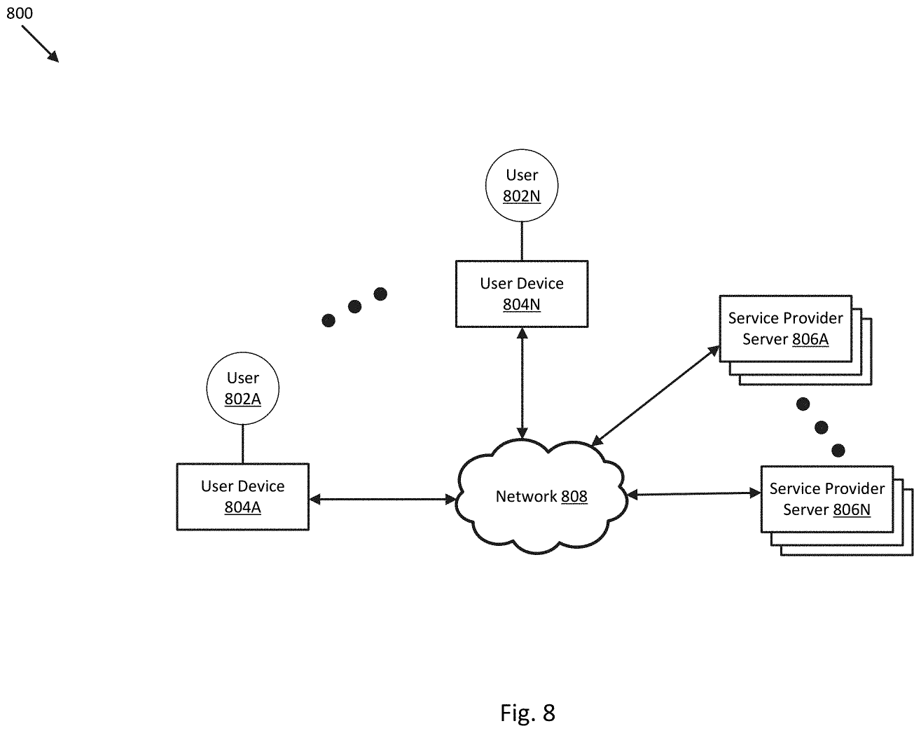

Referring now to FIG. 8, a block diagram of a networked system 800 configured to facilitate one or more processes in accordance with various embodiments of the present disclosure is illustrated. System 800 includes user devices 804A-804N and electronic service provider servers 806A-806N. A user 802A is associated with user device 804A, where user 802A can provide an input to service provider servers 806A-806N using user device 804A. Users 802A+1 through 802N may be associated with user devices 804A+1 through 804N, where users 802A+1 through 802N can provide an input to service provider servers 806A-806N using their respective user device.

User devices 804A-804N and service provider servers 806A-806N may each include one or more processors, memories, and other appropriate components for executing instructions such as program code and/or data stored on one or more computer-readable mediums to implement the various applications, data, and operations described herein. For example, such instructions may be stored in one or more computer-readable media such as memories or data storage devices internal and/or external to various components of system 800, and/or accessible over a network 808. Each of the memories may be non-transitory memory. Network 808 may be implemented as a single network or a combination of multiple networks. For example, in various embodiments, network 808 may include the Internet or one or more intranets, landline networks, and/or other appropriate types of networks.

User device 804A may be implemented using any appropriate hardware and software configured for wired and/or wireless communication over network 808. For example, in some embodiments, user device 804A may be implemented as a personal computer (PC), a mobile phone, personal digital assistant (PDA), laptop computer, and/or other types of computing devices capable of transmitting and/or receiving data, such as an iPhone™, Watch™, or iPad™ from Apple™.

User device 804A may include one or more browser applications which may be used, for example, to provide a convenient interface to facilitate responding to requests over network 808. For example, in one embodiment, the browser application may be implemented as a web browser configured to view information available over the internet and respond to requests sent by service provider servers 806A-806N. User device 804A may also include one or more toolbar applications which may be used, for example, to provide client-side processing for performing desired tasks in response to operations selected by user 802A. In one embodiment, the toolbar application may display a user interface in connection with the browser application.

User device 804A may further include other applications as may be desired in particular embodiments to provide desired features to user device 804A. For example, the other applications may include an application to interface between service provider servers 806A-806N and the network 808, security applications for implementing client-side security features, programming client applications for interfacing with appropriate application programming interfaces (APIs) over network 808, or other types of applications. In some cases, the APIs may correspond to service provider servers 806A-806N. The applications may also include email, texting, voice, and instant messaging applications that allow user 802A to send and receive emails, calls, and texts through network 808, as well as applications that enable the user 802A to communicate to service provider servers 806A-806N. User device 804A includes one or more device identifiers which may be implemented, for example, as operating system registry entries, cookies associated with the browser application, identifiers associated with hardware of user device 804A, or other appropriate identifiers, such as those used for user, payment, device, location, and or time authentication. In some embodiments, a device identifier may be used by service provider servers 806A-806N to associate user 802A with a particular account maintained by the service provider servers 806A-806N. A communications application with associated interfaces facilitates communication between user device 804A and other components within system 800. User devices 804A+1 through 804N may be similar to user device 804A.

Service provider servers 806A-806N may be maintained, for example, by corresponding online service providers, which may provide electronic transaction services in some cases. In this regard, service provider servers 806A-806N may include one or more applications which may be configured to interact with user devices 804A-804N over network 808 to facilitate the electronic transaction services. Service provider servers 806A-806N may maintain a plurality of user accounts (e.g., stored in a user account database accessible by service provider servers 806A-806N), each of which may include account information associated with individual users, and some of which may have linked tokens as discussed herein. Service provider servers 806A-806N may perform various functions, including communicating over network 808 with each other, and in some embodiments, a payment network and/or other network servers capable a transferring funds between financial institutions and other third-party providers to complete transaction requests and process transactions.

FIG. 9 illustrates a block diagram of a computer system 900 suitable for implementing one or more embodiments of the present disclosure. It should be appreciated that each of the devices utilized by users, entities, and service providers discussed herein (e.g., the computer system) may be implemented as computer system 900 in a manner as follows.

Computer system 900 includes a bus 902 or other communication mechanism for communicating information data, signals, and information between various components of computer system 900. Components include an input/output (I/O) component 904 that processes a user action, such as selecting keys from a keypad/keyboard, selecting one or more buttons or links, etc., and sends a corresponding signal to bus 902. I/O component 904 may also include an output component, such as a display 911 and a cursor control 913 (such as a keyboard, keypad, mouse, etc.). I/O component 904 may further include NFC communication capabilities. An optional audio I/O component 905 may also be included to allow a user to use voice for inputting information by converting audio signals. Audio I/O component 905 may allow the user to hear audio. A transceiver or network interface 906 transmits and receives signals between computer system 900 and other devices, such as another user device, an entity server, and/or a provider server via network 808. In one embodiment, the transmission is wireless, although other transmission mediums and methods may also be suitable. Processor 912, which may be one or more hardware processors, can be a micro-controller, digital signal processor (DSP), or other processing component, processes these various signals, such as for display on computer system 900 or transmission to other devices via a communication link 918. Processor 912 may also control transmission of information, such as cookies or IP addresses, to other devices.

Components of computer system 900 also include a system memory component 914 (e.g., RAM), a static storage component 916 (e.g., ROM), and/or a disk drive 917. Computer system 900 performs specific operations by processor 912 and other components by executing one or more sequences of instructions contained in system memory component 914. Logic may be encoded in a computer-readable medium, which may refer to any medium that participates in providing instructions to processor 912 for execution. Such a medium may take many forms, including but not limited to, non-volatile media, volatile media, and transmission media. In various implementations, non-volatile media includes optical or magnetic disks, volatile media includes dynamic memory, such as system memory component 914, and transmission media includes coaxial cables, copper wire, and fiber optics, including wires that comprise bus 902. In one embodiment, the logic is encoded in non-transitory computer readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 900. In various other embodiments of the present disclosure, a plurality of computer systems 900 coupled by communication link 918 to the network 808 (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure.

What is claimed is:

1. A computer system comprising:
a non-transitory memory storing instructions; and
one or more hardware processors configured to execute the instructions and cause the computer system to perform operations comprising:
accessing a plurality of user accounts created within a past period;
generating a first tree of user accounts of the plurality of user accounts by recursively identifying pairs of the user accounts for each branch of the first tree, wherein the recursively identifying comprises:
for each user account, beginning with a seed account for the first tree, determining whether the user account has been paired to one or more other user accounts based on respective hard link features and soft link features; and
if the user account has been paired to the one or more other user accounts, adding the one or more other user accounts to a branch level below the user account in the first tree; and
generating a first cluster comprised of the user accounts of the first tree.

2. The computer system of claim 1, wherein the operations further comprise:
determining a second tree of user accounts of the plurality of user accounts by recursively identifying pairs of the user accounts for each branch of the second tree;
determining that the second tree has a same user account with the first cluster; and
based on the second tree having the same user account with the first cluster, generating a second cluster comprised of each distinct user account in the first cluster and the second tree.

3. The computer system of claim 1, wherein a first account is the seed account for the first tree, and wherein the operations further comprise pairing the first account to one or more user accounts during the past period, the pairs between the first account and the one or more user accounts forming a first level branch of the first tree.

4. The computer system of claim 3, wherein the pairing is performed using a machine learning model trained based on training data comprising labeled seed-vertex pairs of user accounts.

5. The computer system of claim 4, wherein the operations further comprise:
generating training data by:
identifying user accounts that share hard link features with a seed account;
splitting the user accounts into seed-vertex pairs with the seed account;
enhancing the seed-vertex pairs with soft link features; and
labeling the seed-vertex pairs such that the seed-vertex pairs can be used to train the machine learning model to predict user account pairs.

6. The computer system of claim 1, wherein the operations further comprise restricting one or more account capabilities of the user accounts in the first cluster.

7. The computer system of claim 1, wherein the operations further comprise unifying the first cluster with a second cluster of user accounts that was generated prior to the generating the first cluster.

8. A method comprising:
accessing a first user account of a plurality of user accounts created within a past period on an electronic service provider platform;
pairing the first user account with one or more user accounts of the plurality of user accounts;
recursively identifying user accounts at each branch level of a first tree based on pairings of the user accounts created during the past period, wherein the recursively identifying comprises:
for each user account, beginning with the first user account as a seed account for the first tree, determining whether the user account has been paired to one or more other user accounts based on respective hard link features and soft link features; and
if the user account has been paired to the one or more other user accounts, adding the one or more other user accounts to a branch level below the user account in the first tree; and
generating a first cluster comprised of the user accounts of the first tree.

9. The method of claim 8, further comprising:
pairing a second user account with one or more user accounts of the plurality of user accounts;
recursively identifying user accounts at each branch level of a second tree, beginning with the second user account as a seed account for the second tree, wherein the second user account paired to the one or more user accounts forms a first level branch of the second tree; and
generating a second cluster comprised of the user accounts of the second tree.

10. The method of claim 9, further comprising
determining that the second cluster and the first cluster share a same user account; and
unifying the first cluster and the second cluster such that each distinct user account in the first cluster and the second cluster is assigned to a unified third cluster.

11. The method of claim 8, wherein the pairing is performed using a machine learning model trained using training data comprising labeled seed-vertex pairs of user accounts.

12. The method of claim 11, further comprising generating the training data by:
accessing sample user accounts created during a certain period of time on the electronic service provider platform;
identifying user accounts that share hard link features with the sample user accounts;
splitting the sample user accounts and corresponding identified user accounts that share hard link features into seed-vertex pairs;
enhancing the seed-vertex pairs with soft link features; and
labeling the seed-vertex pairs such that the seed-vertex pairs can be used to train the machine learning model.

13. The method of claim 8, further comprising:
determining that the first cluster is associated with a fraudulent user activity; and
restricting one or more account capabilities of the user accounts in the first cluster.

14. The method of claim 8, wherein the first user account is a most recently created user account during the past period on the electronic service provider platform, and wherein the method is performed for each most recently created user account during the past period on the electronic service provider platform.

15. A non-transitory machine-readable medium having instructions stored thereon, wherein the instructions are executable to cause a machine of a system to perform operations comprising:
accessing a first user account of a plurality of user accounts created within a past period on an electronic service provider platform;
pairing the first user account with one or more user accounts of the plurality of user accounts;
identifying user accounts for each branch level of a first tree, beginning with the first user account as a seed account for the first tree, by recursively iterating through each paired user account as a seed account in a respective tree; and
generating a first cluster comprised of the user accounts of the first tree.

16. The non-transitory machine-readable medium of claim 15, wherein the operations further comprise:
pairing a second user account with one or more user accounts of the plurality of user accounts;
identifying user accounts for each branch level of a second tree, beginning with the second user account as a seed account for the second tree, by recursively iterating through each paired user account as a seed account in a respective tree, wherein the second user account paired to the one or more user accounts forms a first level branch of a second tree; and
generating a second cluster comprised of the user accounts of the second tree.

17. The non-transitory machine-readable medium of claim 16, wherein the operations further comprise:
determining that the first cluster and the second cluster have at least one user account in common; and
based on the first cluster and the second cluster having at least one user account in common, unifying the first cluster and the second cluster such that each distinct user account in the first cluster and the second cluster is assigned to a unified third cluster.

18. The non-transitory machine-readable medium of claim 15, wherein the pairing is performed using a machine learning model trained using training data comprising labeled seed-vertex pairs of user accounts.

19. The non-transitory machine-readable medium of claim 18, wherein the operations further comprise generating the training data for the machine learning model by:
accessing sample user accounts created during a certain period of time for the electronic service provider platform;
identifying user accounts that share hard link features with the sample user accounts;
splitting the sample user accounts and corresponding identified user accounts that share hard link features into seed-vertex pairs;
enhancing the seed-vertex pairs with soft link features; and
labeling the seed-vertex pairs such that the seed-vertex pairs can be used to train the machine learning model.

20. The non-transitory machine-readable medium of claim 15, wherein the operations further comprise disabling a withdrawal capability of the user accounts in the first cluster.
